(19) United States
(12) Patent Application Publication
(10) Pub. No.: US 2005/0264405 A1
(43) Pub. Date: Dec. 1, 2005

(54) Tire pressure-monitoring apparatus

(75) Inventor: Shingo Ueda, Tokyo (JP)

Correspondence Address: FOLEY AND LARDNER;SUITE 500, 3000 K STREET NW, WASHINGTON, DC, 20007, US

(73) Assignee: CALSONIC KANSEI CORPORATION

(21) Appl. No.: 11/127,300

(22) Filed: May 12, 2005

(30) Foreign Application Priority Data
May 13, 2004 (JP) 2004-143357

(51) Int. Cl. B60C 23/00

(52) U.S. Cl. 340/442

(57) ABSTRACT

A tire pressure monitoring apparatus comprising sensors each for detecting an air pressure of each of tires as a tire pressure, an warning generation necessity-judging unit, and a running-judging unit. The warning generation necessity-judging unit compares the detected tire pressure with a warning threshold value and generates a warning generation-ordering command if it is judged that the tire pressure decreases. The warning generation necessity-judging unit sets two kinds of pressure values: an urgent warning threshold value and a delayed warning threshold value as said warning threshold value. If the tire pressure is lower than the urgent warning threshold value, a warning generating order is generated. If the tire pressure is between the urgent warning generation threshold value and the delayed warning threshold value, the running-judging unit judges whether the vehicle is in a running state or not. Then, the warning generation necessity-judgment unit generates a warning generation-ordering command, if it is judged that the vehicle is in the running state and a tire pressure detected again remains lower than said delayed warning threshold value.

### BACKGROUND OF THE INVENTION

(1) Field of the Invention

The present invention relates to a tire pressure-monitoring apparatus adapted to generate a warning when it is judged, through detecting an air pressure of each of tires as a tire pressure and comparing the detected tire pressure with the warning threshold value, that a tire pressure decreases beyond a warning threshold value,

(2) Related Art Statement

A tire pressure-monitoring apparatus has been formerly known, in which the air pressure (hereinafter referred to as “tire pressure) of a tire 1 for a vehicle 9 is monitored and a warning is generated to a driver when the tire pressure is lower than a specified value (JP-A 2000-190719, FIGS. 1 and 2, paragraphs 0002 and 0003).

The tire pressure-monitoring apparatus shown in FIG. 5 comprises tire pressure detectors each including a tire pressure sensor 2, a receiving unit 3 for receiving the detected tire pressures, a controller 10, and warning lamps 8 each for generating a warning when the tire pressure is lower than the specified value.

The tire pressures of the tires 1, 1, 1 and 1 are measured by the tire pressure sensor 2, 2, 2, 2, respectively, and are wirelessly transmitted to the receiver 3. The tire pressures received by the receiver 3 are sent to the controller 10 via a tuner 4.

As shown in FIG. 6, the controller 10, which receives tire pressure data, comprises a RAM 12, an EEPROM 11 and a CPU 13 as an arithmetic processing unit.

Tire pressure data detected at a predetermined time interval are stored in the RAM 12, which is a memory unit to temporarily write and read out.

The warning threshold value as a warning-generating standard is preliminarily stored in the EEPROM 11 which is a read-on-memory of which stored information can be electrically erased.

The controller 10 compares the tire pressure data with the warning threshold value D, and makes an warning to be generated by lighting a warning lamp 8 if the tire pressure is lower than the warning threshold value D.

The lit warning lamp 8 is turned off when the tire pressure exceeds a return pressure threshold value C.

However, only one warning threshold value D is set in the conventional tire pressure-monitoring apparatus, so that the warning lamp 8 is lit if the detected tire pressure decreases lower than the warning threshold value D irrespective of the state of the vehicle 9.

For this reason, if the vehicle 9 is parked for a long time period in a temperature-low place as in a cold region, it is feared that the warning lamp 8 is lit even at a tire pressure which would return to its normal state when the tire is warmed after running.

That is, it is highly possible that as shown in FIG. 7, even through the tire pressure gradually lowers due to decrease in temperature, the tire pressure is restored as indicated by an alternate long and short dash line.

If the warning is generated even in this case, the driver is obliged to perform unnecessary adjustment of the tire pressure.

### SUMMARY OF THE INVENTION

Under the circumstances, the present invention is to provide a tire pressure-monitoring apparatus which can reduce erroneous operations to generate warnings even when the tire pressure is in a normal state.

In order to attain the above object, the tire pressure-monitoring apparatus according to the present invention comprising sensors each for detecting an air pressure of each of tires as a tire pressure, an warning generation necessity-judging unit, and a running-judging unit, said warning generation necessity-judging unit being adapted to compare the detected tire pressure with a warning threshold value and generate a warning generation-ordering command if it is judged that the tire pressure decreases, wherein said warning generation necessity-judging unit sets two kinds of pressure values: an urgent warning threshold value and a delayed warning threshold value as said warning threshold value; if the tire pressure is lower than the urgent warning threshold value, a warning generating order is generated; if the tire pressure is between the urgent warning generation threshold value and the delayed warning threshold value, the running-judging unit judges whether the vehicle is in a running state or not; and the warning generation necessity-judgment unit generates a warning generation-ordering command if it is judged that the vehicle is in the running state and a tire pressure detected again remains lower than said delayed warning threshold value.

According to the thus constructed tire pressure-monitoring apparatus of the present invention, two kinds of the warning threshold values: the urgently warning threshold value and the delayed warning threshold value are set, and the warning is not instantly generated even if the tire pressure is between the urgent warning threshold value and the delayed warning threshold value.

In the present invention, it is judged whether the vehicle is running or not, and the warning is generated when the vehicle is running and the tire pressure detected again remains lower than the delayed warning threshold value.

This makes it possible to prevent an erroneous operation in which a warning is generated despite the tire pressure being in the normal state as in the case that the vehicle is parked in the cold place for a long time.

The following embodiments (1) and (2) are preferred embodiments of the tire pressure-monitoring apparatus according to the present invention.

(1) The running-judging unit detects vehicle speed signals until a predetermined time period lapses, accumulates time periods during which the vehicle speed signals are not less than a predetermined vehicle speed signal, and judges that the vehicle is in the running state if the accumulated time period exceeds a predetermined time period.

The accumulated amount of the time periods when the vehicle speeds are not smaller than the predetermined vehicle speed is used to judge whether the vehicle is running or not.

Even if the vehicle is running at a low speed or after the parking time period is long, it cannot be said that the tire is in such a running condition as warming it.

Under the circumstances, the actual running state can be accurately judged by using the accumulated amount of the time periods during which the vehicle speeds are not less than the predetermined vehicle speed.

(2) If a vehicle speed signal is detected even after a lapse of a predetermined time period as counted from a point of time when the vehicle speed signal is detected, the running-judging unit judges that the vehicle is in the running state.

(3) The running-judging unit judges that the vehicle is running, when a vehicle speed signal is detected after lapse of a predetermined time period as counted from a point of time when the previous vehicle speed signal is detected.

Whether the vehicle is running or not is judged based on the presence or absence of the vehicle speed signal. That is, if the vehicle speed signal can be detected after lapse of a predetermined time period as counted from a point of time when the previous vehicle speed signal is detected, it is judged that the vehicle is in the running state.

Since the vehicle speed signals obtained by the vehicle speed sensor are signals obtained in a general vehicle, no special sensor is necessary, resulting in inexpensive construction of the tire pressure-monitoring apparatus for the predetermined time period.

### BRIEF DESCRIPTION OF THE ATTACHED DRAWINGS

For a better understanding of the invention, reference is made of the attached drawings, wherein:

FIG. 1 is a view of the entire construction of a tire pressure-monitoring apparatus according to a best embodiment of the present invention.

FIG. 2 is a block diagram for illustrating the construction of a control unit of the tire pressure-monitoring apparatus according to the present invention.

FIG. 3 is a flow chart for illustrating the processing flow of the tire pressure-monitoring apparatus.

FIG. 4 is a diagram showing the relationship between the tire pressure and the time period for illustrating a case where the tire pressure-monitoring apparatus generates a warning.

FIG. 5 is a view of the entire construction of the conventional tire pressure-monitoring apparatus according to the present invention.

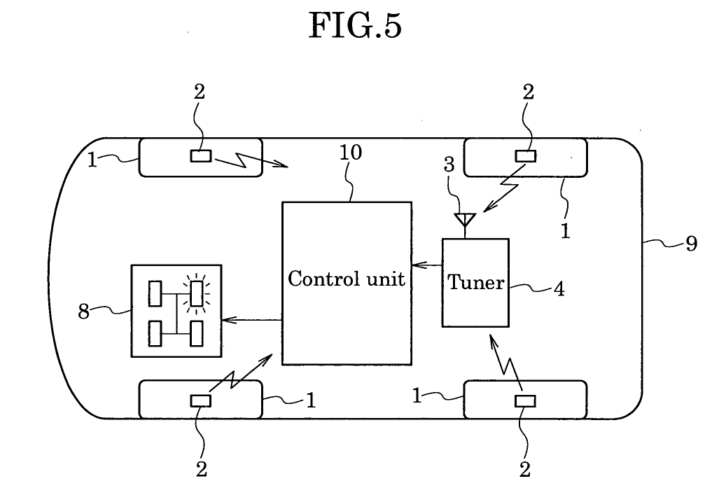

FIG. 6 is a block diagram for illustrating the construction of a control unit of the conventional tire pressure-monitoring apparatus.

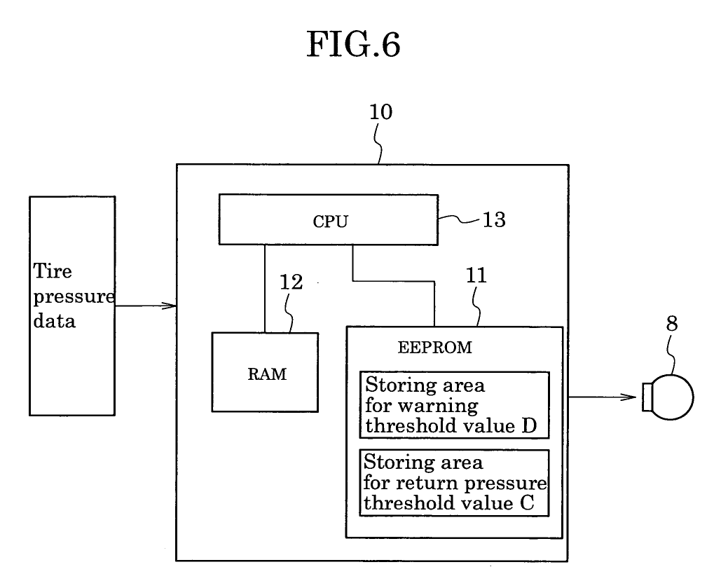

FIG. 7 is a diagram showing the relationship between the tire pressure and the time period for illustrating a case where the tire pressure-monitoring apparatus generates a warning.

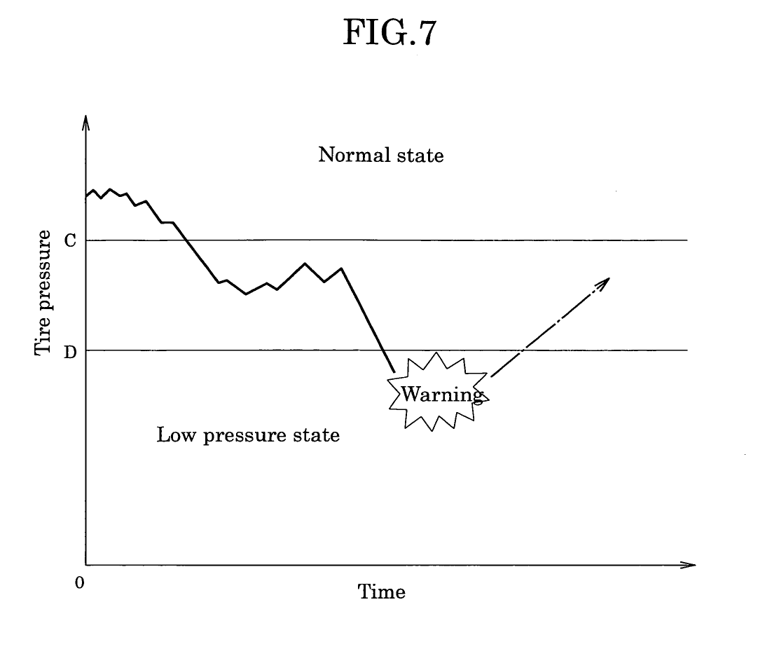

### BEST MODES FOR CARRYING OUT THE INVENTION

The best mode of the present invention will be explained below with reference to the drawings.

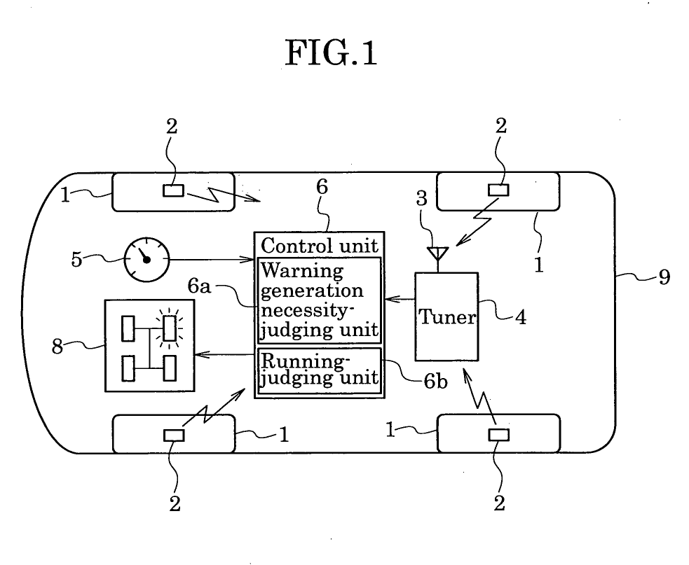

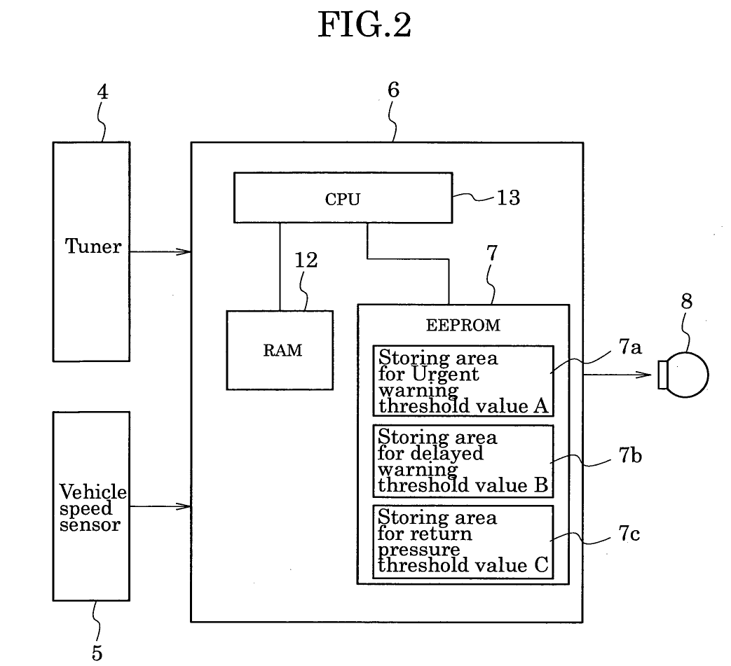

FIGS. 1 and 2 show the construction of the tire pressure-monitoring apparatus according to the present invention.

First referring to the construction, the tire pressure-monitoring apparatus according to the present embodiment comprises tire pressure detectors each including a tire pressure sensor 2, a receiving unit 3 for receiving detected tire pressures, a vehicle speed sensor 5 for detecting a vehicle speed signal, a control unit 6 and a warning lamp 8 for generating a warning when the tire pressure decreases.

The tire pressure sensor 2 is attached to a load wheel, and transmits the detected tire pressure of the tire 1 to the receiving unit 3 as a wireless signal.

In this embodiment, the locations of the tires can be discriminated by transmitting identification codes (ID) of the respective tires 1, 1, 1 and 1 in addition to the detection of the tire pressure of each of the tires.

The detection of the tire is carried out every predetermined time interval. For example, when the vehicle is in a running state, the tire pressure is detected every few minutes, whereas the tire pressure is detected every a few hours when the vehicle is stopped, the tire pressure is detected every a few hours. The detected tire pressure is transmitted to the receiving unit 3.

The tire pressure received by the receiving unit 3 is transmitted to the controller 6 via the tuner 4.

According to the present invention, since the running state of the vehicle 9 needs to be confirmed depending upon the detected tire pressure, vehicle speed signals are sent to the controller 6.

The vehicle speed signals can be obtained by the vehicle speed sensor 5 arranged in a speed meter.

The controller 6 comprises a warning generation necessity-judgment unit 6a to judge whether warning is to be generated or not and a running-judging unit 6b to judge whether the vehicle 9 is in the running state or not.

The controller 6 comprises a RAM 12, an EEPROM 7 and a CUP 13 as an arithmetic processing unit. The RAM 12 functions as a memory unit to temporarily write tire pressure data and reading out them. The EEPROM 7 functions as a ROM of which memory information can be electrically erased.

Two kinds of warning threshold values D and a return pressure threshold value C are preliminarily stored in respective storing areas 7a, 7b and 7c of the EEPROM 7.

Two kinds of the warning threshold values are an urgent warning threshold value A having a lower pressure level and a delayed warning threshold value 13 having a higher one.

The controller 6 compares a detected tire pressure with the warning threshold values A and B stored in the EEPROM 7, and transmits a command for lighting the warning lamp 8 when the tire pressure is in the lower pressure level.

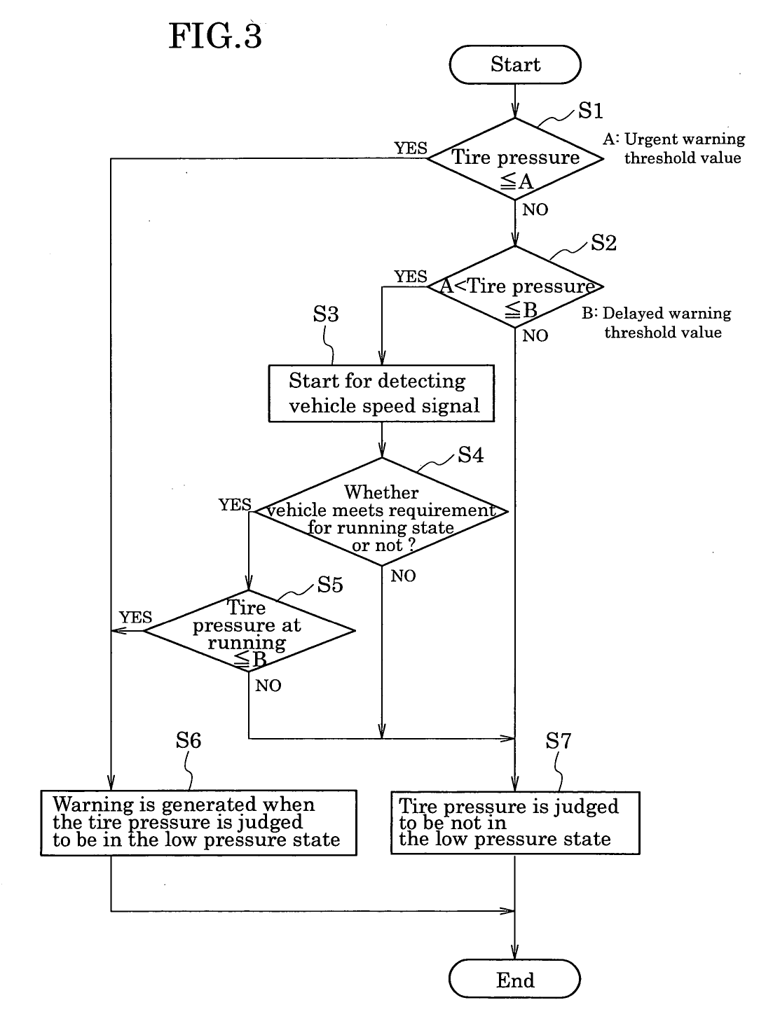

Next, the function of the above-mentioned tire pressure-monitoring apparatus will be explained with reference to the flow chart shown in FIG. 3.

The tire pressure detected from each of the tires 1, 1, 1, 1 is compared with the urgent warning threshold value A (S1). Based on a comparison result, when the tire pressure is not higher than the urgent warning threshold value A, it is instantly judged that the tire pressure is in the lower pressure state. Then, warning is generated by lighting the warning lamp 8 (S6).

When the tire pressure is higher than the urgent warning threshold value A, the tire pressure is compared with the delayed warning threshold value B (S2). When the tire pressure is higher than the delayed warning threshold value B, it is judged that the tire pressure is not in the lower pressure state. Then, processing is terminated without generating warning (S7).

If the tire pressure is higher than the urgent warning threshold value A and not higher than the delayed threshold value B (A<tire pressure≦B), whether the vehicle 9 is in the running state or not is confirmed according to the following procedure.

First, a vehicle speed signal begins to be detected by starting a timer (S3). Then, an accumulated amount of time periods during which the vehicle is not lower than a predetermined vehicle speed within a given time period set by the timer is calculated.

For example, 7 minutes are set by starting the timer, and vehicle speed signals are detected for the 7 minutes. The time periods during which the vehicle speed is not lower than 30 km/h, for example, are accumulated.

If the condition that the vehicle 9 is in the running state is set such that the accumulated amount of the time periods during which the vehicle speed is not lower than 30 km/h is 3 minutes or more, the accumulated amount of the time periods is compared with the set condition (S4).

If it is judged that the vehicle is not in the running state because the accumulated amount of the time periods during which the vehicle speed is not lower than 30 km/h is less than 3 minutes, the tire pressure is not in the lower pressure state. Thus, the processing is terminated (S7).

If it is judged that the vehicle is in the running state because the accumulated amount of the time periods during which the vehicle speed is not lower than 30 km/h is 3 minutes or more, the tire pressure (the tire pressure at the time of running) is detected again to confirm whether the tire pressure is not higher than the delayed warning threshold value B or not (S5).

If the tire pressure at the time of running remains at not higher than the delayed warning threshold value B, warning is generated through judging that the tire pressure is in the lower state (S6).

On the other hand, if the tire is warmed through running to restore the tire pressure and the tire pressure at the time of running is higher than the delayed threshold value B, it is judged that the tire pressure is not in the lower pressure state. Thereby, the processing is terminated (S7).

If the warning lamp 8 is lit to generate warning, the lamp is turned off when the tire pressure becomes the return pressure threshold value C or higher.

The thus constructed tire pressure-monitoring apparatus does not instantly generate warning even if the tire pressure becomes not higher than the delayed tire pressure B.

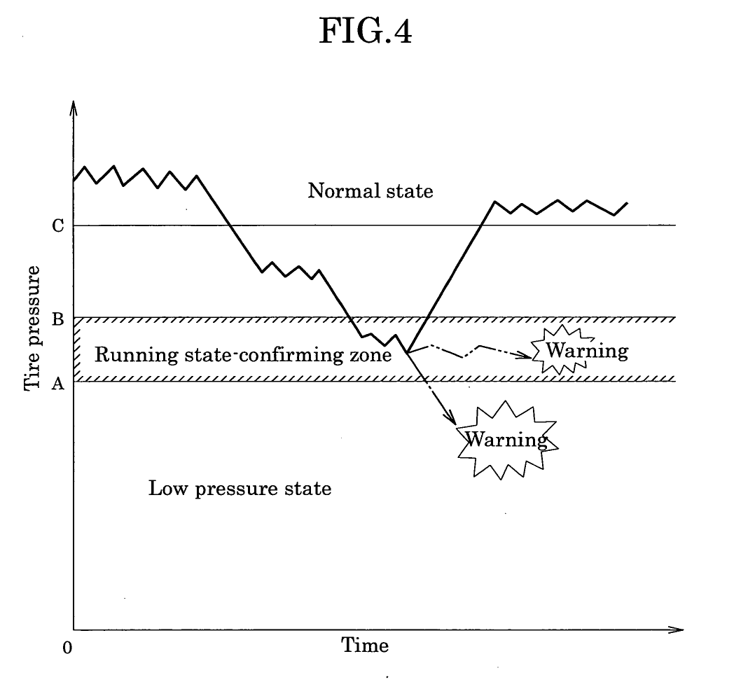

As shown by a long and short dash line in FIG. 4, if the tire pressure becomes lower than the urgent warning threshold value A, warning is immediately generated by judging that the tire pressure is in the lower pressure state.

However, the tire pressure may return to the normal state again even if the tire pressure becomes not higher than the delayed warning value B (Solid line in FIG. 4).

If the tire pressure is in a running state-confirming zone between the urgent warning threshold value A and the delayed warning threshold value B, it is confirmed whether the vehicle 9 is in the running state or not. Warning is generated only when the tire pressure is not higher than the delayed threshold value B although the vehicle is in the running state.

In case that a single warning threshold value is set as conventionally, the warning threshold value D is set nearer to the delayed warning threshold value B in the present invention so as to ensure safety.

For this reason, even if the tire pressure merely decreases because the vehicle is parked in a temperature-low site for a long time period, an erroneous operation generating warning conventionally occurred.

To the contrary, two kinds of the warning threshold values are set in the tire pressure-monitoring apparatus according to the present invention. Therefore, if the tire pressure may be normal, warning is generated after it is confirmed whether the vehicle 9 is in the running state or not. Thus, warning is seldom generated due to an erroneous operation.

Further, when the running state is judged based on the accumulated amount of the time periods during when the vehicle speed is not lower than the predetermined vehicle speed, the actual running state as to whether the vehicle is run to warm the tire or not can be accurately judged.

Further, since the running state is confirmed by utilizing the vehicle speed sensor 6 attached to the common vehicle 9, the tire pressure monitoring apparatus can be constructed inexpensively.

The best mode of the present invention has been explained above with reference to the attached drawings. The concrete construction is not limited to this embodiment, and any modification in design is included in the present invention so long as such is deviated from the gist of the invention.

For example, in the above embodiment, the judgment standard of “not more than the urgent warning threshold value A” and “not more than the delayed warning threshold value B” is employed. However, a judgment standard of “less than the urgent warning threshold value A” and “less than the delayed warning threshold value B” may be employed,

The running-judgment unit 6b may judge that the vehicle 9 is running if a vehicle speed signal is detected even after a lapse of a predetermined time period as counted from a point of time when a vehicle speed signal was first detected.

For example, it may be that if a vehicle speed signal is detected after a lapse of 10 minutes counted from a point of time when a start of running of the vehicle was detected according to generation of a vehicle speed signal, the vehicle is judged to be in a running state.

1. A tire pressure monitoring apparatus comprising sensors each for detecting an air pressure of each of tires as a tire pressure, an warning generation necessity-judging unit, and a running-judging unit, said warning generation necessity-judging unit being adapted to compare the detected tire pressure with a warning threshold value and generate a warning generation-ordering command if it is judged that the tire pressure decreases, wherein said warning generation necessity-judging unit sets two kinds of pressure values: an urgent warning threshold value and a delayed warning threshold value as said warning threshold value; if the tire pressure is lower than the urgent warning threshold value, a warning generating order is generated; if the tire pressure is between the urgent warning generation threshold value and the delayed warning threshold value, the running-judging unit judges whether the vehicle is in a running state or not; and the warning generation necessity-judgment unit generates a warning generation-ordering command if it is judged that the vehicle is in the running state and a tire pressure detected again remains lower than said delayed warning threshold value.

2. The tire pressure-monitoring apparatus set forth in claim 1, wherein said running-judging unit detects vehicle speed signals until a predetermined time period lapses, accumulates time periods during which the vehicle speed signals are not less than a predetermined vehicle speed signal, and judges that the vehicle is in the running state if the accumulated time period exceeds a predetermined time period.

3. The tire pressure-monitoring apparatus set forth in claim 1, wherein if a vehicle speed signal is detected even after a lapse of a predetermined time period as counted from a point of time when the vehicle speed signal is detected, the running-judging unit judges that the vehicle is in the running state.

4. A tire pressure monitoring apparatus comprising sensors each for detecting an air pressure of each of tires as a tire pressure, a receiver for receiving the detected pressures of the tires, a vehicle speed sensor, a control unit and a warning lamps for generating a warning when a tire pressure in a lower state, the tire pressure received by the receiver and the vehicle speed signal detected by the vehicle speed sensor being transmitted to the control unit, said control unit comprises an warning generation necessity-judging unit and a running-judging unit, said warning generation necessity-judging unit being adapted to compare the detected tire pressure with a warning threshold value and generate a warning generation-ordering command if it is judged that the tire pressure decreases, wherein said warning generation necessity-judging unit sets two kinds of pressure values: an urgent warning threshold value and a delayed warning threshold value as said warning threshold value; if the tire pressure is lower than the urgent warning threshold value, a warning generating order is generated; if the tire pressure is between the urgent warning generation threshold value and the delayed warning threshold value, the running-judging unit judges whether the vehicle is in a running state or not; and the warning generation necessity-judgment unit generates a warning generation-ordering command if it is judged that the vehicle is in the running state and a tire pressure detected again remains lower than said delayed warning threshold value.

5. The tire pressure-monitoring apparatus set forth in claim 4, wherein said running-judging unit detects vehicle speed signals until a predetermined time period lapses, accumulates time periods during which the vehicle speed signals are not less than a predetermined vehicle speed signal, and judges that the vehicle is in the running state if the accumulated time period exceeds a predetermined time period.

6. The tire pressure-monitoring apparatus set forth in claim 4, wherein if a vehicle speed signal is detected even after a lapse of a predetermined time period as counted from a point of time when the vehicle speed signal is detected, the running-judging unit judges that the vehicle is in the running state.
